(19) United States
(12) Patent Application Publication
(10) Pub. No.: US 2026/0030495 A1
(43) Pub. Date: Jan. 29, 2026

(54) AUGMENTATION AND TRANSFORMATION OF RELATIONALLY STORED DATA FOR ENRICHMENT AND INSTRUCTION FINE TUNING OF LANGUAGE PROCESSING MACHINE LEARNING MODELS

(71) Applicant: INTUIT INC., Mountain View, CA (US)

(72) Inventors: Aleksandr KIM, Tel Aviv (IL); Nitzan Gado SAGINHOR, Ness ziona (IL); Joseph Neil GARFINKEL, Raanana (IL)

(21) Appl. No.: 18/787,353

(22) Filed: Jul. 29, 2024

(51) Int. Cl. G06N 3/08

(52) U.S. Cl. CPC G06N 3/08

(57) ABSTRACT

Aspects of the present disclosure provide techniques for training a language processing machine learning model. Embodiments include retrieving a set of raw data from a data store. Embodiments include populating, based on the set of data, a natural language response template that is associated with a sample natural language prompt. Embodiments include providing the sample natural language prompt and the set of raw data as training inputs to the language processing machine learning model. Embodiments include receiving a training output from the language processing machine learning model in response to the training inputs. Embodiments include adjusting one or more parameters of the language processing machine learning model based on comparing the training output to the populated natural language response template.

### INTRODUCTION

Aspects of the present disclosure relate to techniques for augmenting and transforming relationally stored data to generate natural language training data for use in fine tuning of language processing machine learning models.

### BACKGROUND

Every year millions of people, businesses, and organizations around the world utilize software applications to assist with countless aspects of life. Some software applications utilize language processing machine learning models, such as for automated content generation, automated support and/or chat functionality, and/or a variety of other purposes.

Training or fine tuning of language processing machine learning models such as large language models (LLMs) for a particular purpose generally requires significant amounts of training data relevant to that particular purpose. Often data that is relevant to a particular purpose and that could potentially used in a training or fine tuning process is not stored in a manner that enables such data to be used for training or fine tuning a language processing machine learning model, such as not being stored in natural language form. Thus, it is challenging to generate sufficient amounts of training data in a natural language form for training or fine tuning a language processing machine learning model for a specific purpose, particularly when data related to the specific format is not typically stored in the form of natural language.

Accordingly, there is a need in the art for improved techniques of generating training data for use in training or fine tuning a language processing machine learning model for specific purposes.

### BRIEF SUMMARY

Certain embodiments provide a method for training a language processing machine learning model. The method generally includes: retrieving a set of raw data from a data store; populating, based on the set of data, a natural language response template that is associated with a sample natural language prompt; providing the sample natural language prompt and the set of raw data as training inputs to the language processing machine learning model; receiving a training output from the language processing machine learning model in response to the training inputs; and adjusting one or more parameters of the language processing machine learning model based on comparing the training output to the populated natural language response template.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 is a diagram illustrating example computing components related to training a language processing machine learning model, according to certain embodiments.

FIG. 2 is a diagram depicting an example of automated generation of training data for training a language processing machine learning model, according to certain embodiments.

FIG. 3 is a diagram depicting an example of training a language processing machine learning model, according to certain embodiments.

FIG. 4 depicts example operations related to training a language processing machine learning model, according to certain embodiments.

FIGS. 5A and 5B depict example processing systems for training a language processing machine learning model, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training a language processing machine learning model.

Training a language processing machine learning model such as a large language model (LLM) generally requires a large amount of natural language training data. For example, a supervised learning process for training a language processing machine learning model to generate natural language responses to particular types of natural language queries generally involves the use of labeled training data that includes “ground truth” examples of such natural language responses for those particular types of queries. However, generating such training data is challenging in many cases, such as in contexts where the available ground truth data is not in natural language form. For example, training a language processing machine learning model to respond to natural language queries about content stored in a relational database that stores information in forms other than natural language may be technically challenging due to the lack of natural language ground truth data for such a purpose.

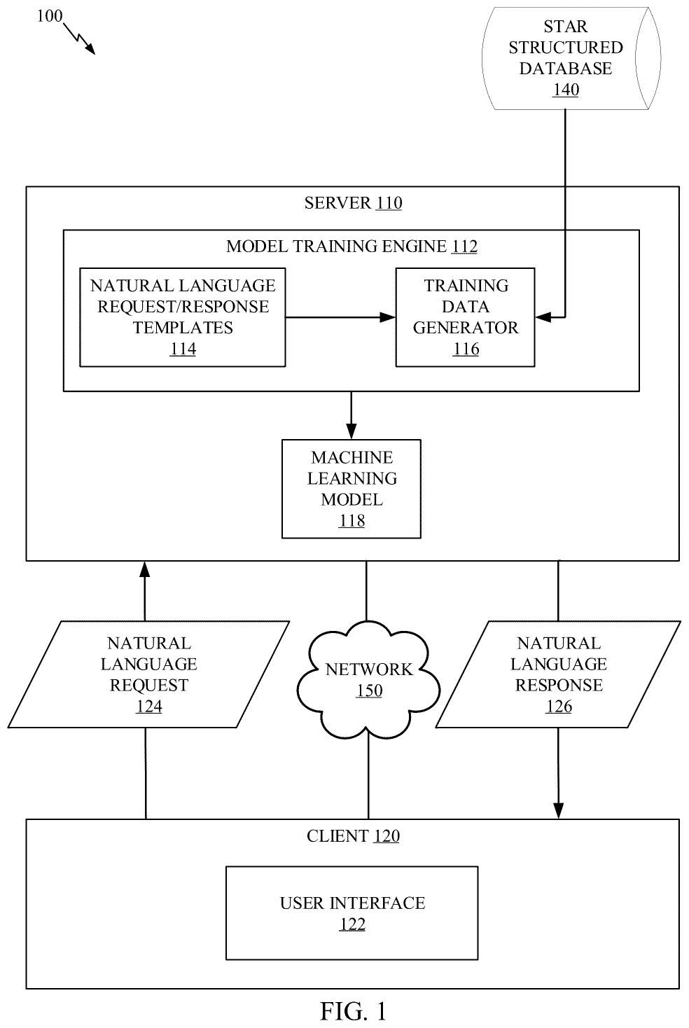

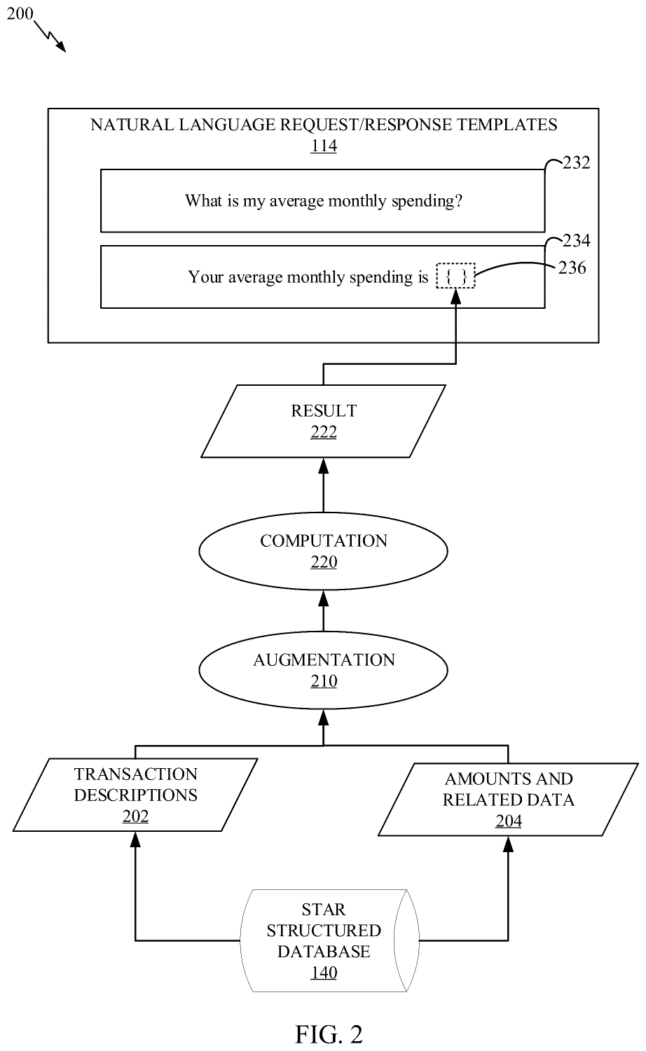

Techniques described herein address the technical challenge of training a language processing machine learning model for a context where the available ground truth data is not in natural language form through the use of an automatic natural language training data generation process based on underlying ground truth data that is not in natural language form. As described in more detail below with respect to FIG. 1, raw data (e.g., including data such as numerical values, dates, textual descriptors, geographic location information, and/or the like) may be retrieved from a data store (e.g., storing such data in a relational manner) and processed, such as to identify related data items and/or to perform certain computations. Results of such processing may be used to automatically populate natural language response templates associated with sample natural language queries. For example, as described in more detail below with respect to FIG. 2, sample natural language queries (e.g., “what is my average monthly spending?”) may be stored in association with natural language response templates that include placeholders to be populated with relevant data (e.g., “your average monthly spending is { }”) in order to generate natural language training data that includes ground truth data transformed into natural language form. Such a process may performed for data relating to multiple users, such as for multiple types of natural language queries, in order to automatically generate significant amounts of natural language training data based on ground truth data that is not natively stored in natural language form.

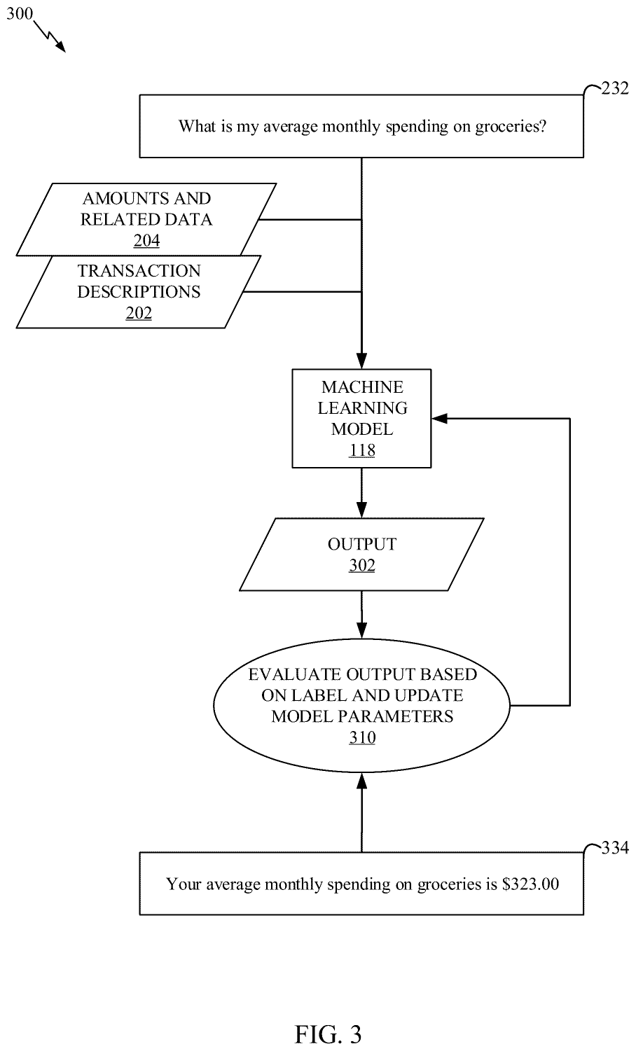

As described in more detail below with respect to FIG. 3, the automatically generated natural language training data may be used to train a language processing machine learning model through a supervised learning process so that the language processing machine learning model learns to formulate appropriate natural language responses based on underlying raw data when presented with natural language queries of the types included in the training data.

Techniques described herein improve the technical field of training language processing machine learning models in a number of ways. For instance, by processing raw data and transforming such data into natural language form through the use of natural language response templates associated with sample natural language queries, embodiments of the present disclosure enable automated generation of natural language training data based on underlying ground truth data that is not natively in the form of natural language queries and responses. Thus, embodiments of the present disclosure allow a language processing machine learning model to be trained to accurately respond to particular types of natural language queries with natural language responses based on underlying data even in cases where available ground truth data for use in training is not natively in natural language form. Furthermore, by augmenting raw data (e.g., textual descriptors of transactions) with related information (e.g., amounts, times, geographic locations, and/or the like) and transforming such augmented data into natural language form through particular computations and templates, techniques described herein enable the automated extraction of particularly relevant ground truth data from relational data sets for use in automated generation of training data, thereby allowing a natural language machine learning model to learn from a more comprehensive and targeted set of natural language training data. Additionally, by automatically generating natural language training data based on ground truth data that is not otherwise in the form of natural language queries and responses, techniques described herein allow a language processing machine learning model trained based on such training data to accurately respond to natural language queries in a way that was not possible previously, thereby reducing errors in model outputs and avoiding computing resource utilization associated with generating and correcting such errors.

### Example Computing Components Related to Training a Language Processing Machine Learning Model

FIG. 1 is a diagram 100 illustrating example computing components related to training a language processing machine learning model, according to certain embodiments.

In diagram 100, a server 110 is connected to a client 120 via a network 150, which may represent any connection over which data may be transmitted (e.g., the Internet). Server 110 is further connected to a star structured database 140, such as via network 150 and/or a different network (or, alternatively, star structured database 140 may be located on server 110).

Server 110 generally represents a computing device, such as a server computer, that runs a model training engine 112 for training a machine learning model 118. In some embodiments, machine learning model 118 may be trained on a separate device from a device on which it is run once trained. Model training engine 112 generally performs operations related to automatically generating natural language training data based on underlying data that is not in the form of natural language queries and responses (e.g., data in star structured database 140), and using such automatically generated natural language training data to train machine learning model 118.

Machine learning model 118 generally represents a language processing machine learning model such as a large language model (LLM). Language processing machine learning models are generally neural networks, such as deep neural networks, that are trained using large amounts of natural language training data to generate natural language responses when provided with natural language queries (e.g., prompts). For example, machine learning model 118 may be a generative pre-trained (GPT) model or other type of language processing machine learning model that has been trained on a large set of training data (e.g., across a plurality of domains), and is capable as a result of such training to perform a wide variety of language-related tasks in response to natural language prompts. In some embodiments model training engine 112 is configured to fine tune machine learning model 118 (e.g., after machine learning model 118 has been trained more generally) for one or more particular domains, such as for use with a particular software application, specific data source (e.g., star structured database 140), or for a specific purpose, while in other embodiments machine learning model 118 has not been trained in advance of training performed by model training engine 112. Machine learning model 118 may have a large number of tunable parameters, which are iteratively adjusted during a supervised learning process based on training data.

Model training engine 112 comprises a training data generator 116 that uses natural language request/response templates 114 to automatically generate natural language training data based on data from one or more data sources such as star structured database 140. Natural language request/response templates 114 may include one or more sample natural language queries associated with corresponding natural language response templates, as described in more detail below with respect to FIG. 2. For example, natural language request/response templates 114 may include the natural language request “what was my total spending last year?” paired with the natural language response template “your total spending last year was { },” where { } is a placeholder that can be populated with ground truth data (e.g., from start structured database 140) to create a natural language training data instance. In another example, natural language request/response templates 114 may include the natural language request “what is my average monthly spending on travel?” paired with the natural language response template “your average monthly travel spending is { },” where { } is a placeholder that can be populated with ground truth data (e.g., from start structured database 140) to create a natural language training data instance. In yet another example, natural language request/response templates 114 may include the natural language request “what was my largest expense last week?” paired with the natural language response template “your largest expense last week was { } for { } on { },” where all three instances of { } are placeholders that can be populated with ground truth data (e.g., from start structured database 140) to create a natural language training data instance (e.g., the first placeholder may be for an amount, the second placeholder may be for a transaction description or categorization, and the third placeholder may be for a day of the week). Each natural language request/response template 114 may be used to create multiple training data instances, such as based on ground truth data determined for a plurality of users and/or in a plurality of different contexts.

In order to generate training data based on a given natural language request/response template 114, training data generator 116 may retrieve relevant data from star structured database 140 for use in determining ground truth data that can be inserted into the natural language response template. Star structured database 140 generally represents a data storage entity that stores data in a relational manner, such as according to a “star schema,” which is a multi-dimensional data model used to organize data in a database so that it is easy to understand and analyze. In one particular example, star structured database 140 stores records of transactions performed by a plurality of users, such as including textual descriptors of transactions associated with various types of contextual information such as amounts, dates, geographic location information, user and/or party identifiers, and/or the like. It is noted that a star structured database is included as an example of a type of data source, and other types of data sources may be used with techniques described herein.

In one example, training data generator 116 augments raw textual data (e.g., brief transaction descriptions or vendor descriptions) retrieved from star structured database 140 with other related data such as amounts, dates, geographic location information, and/or the like. Training data generator 116 may, in some embodiments, perform one or more computations based on the retrieved (e.g., and augmented) data, such as to aggregate values for certain time periods, certain categories, and/or the like, such as by user. Training data generator 116 may then populate one or more natural language response templates in natural language request/response templates 114 based on the augmenting and/or computation(s), such as inserting the results of one or more computations (e.g., sum, average, difference, and/or the like) into one or more placeholders in one or more natural language response templates.

In some embodiments, training data generated by training data generator 116 includes the underlying data retrieved from star structured database 140 along with the natural language requests and corresponding populated natural language response templates. For example, a given training data instance may include a set of raw data (e.g., retrieved from star structured database 140) associated with a natural language request and a corresponding natural language response template that has been automatically populated based on the set of raw data.

Model training engine 112 may use training data generated by training data generator 116 to train machine learning model 118 through a supervised learning process. It is noted that training may also refer in some embodiments to fine tuning or re-training of a model that has been previously trained. An example of training machine learning model 118 is described in more detail below with respect to FIG. 3. For example, a supervised learning process may involve providing training inputs (e.g., a set of raw data and a natural language request) as inputs to machine learning model 118. Machine learning model 118 processes the training inputs and produces outputs (e.g., natural language responses) based on the training inputs. The outputs may be compared to the labels (e.g., populated natural language response templates) associated with the training inputs to determine the accuracy of the model, and parameters of machine learning model 118 may be iteratively adjusted until one or more conditions are met. For instance, the one or more conditions may relate to a loss function for optimizing one or more variables (e.g., relating to model accuracy). In some embodiments, the conditions may relate to whether the outputs produced by the model based on the training inputs match the labels associated with the training inputs or whether a measure of error between training iterations is not decreasing or not decreasing more than a threshold amount. The conditions may also include whether a training iteration limit has been reached. Parameters of machine learning model 118 adjusted during training may include, for example, hyperparameters, values related to numbers of iterations, weights, functions used by nodes to calculate scores, and the like. In some embodiments, validation and testing are also performed for machine learning model 118, such as based on validation data and test data, as is known in the art.

Once trained, machine learning model 118 may be deployed for use in generating natural language responses to natural language requests from one or more client devices such as client 120.

Client 120 generally represents a computing device that is separate from server 110, such as a user device (e.g., desktop or laptop computer, smartphone, tablet, and/or the like). A user interface 122 on client 120 enables a user to provide requests (e.g., through interaction with one or more user interface elements, providing natural language input, and/or the like), receive responses, provide feedback with respect to responses, and/or the like.

In one example, a user requests content via user interface 122, prompting a natural language request 124 to be sent from client 120 to server 110 (e.g., natural language request 124 may be the user's request). The request may, for example, be a request for specific information such as an average amount of monthly spending.

Server 110 may retrieve data related to the user from star structured database 140 (e.g., and may augment raw textual data with other related data such as amounts, dates, geographic locations, and/or the like), and may provide the retrieved data (e.g., the augmented data set) along with natural language request 124 to machine learning model 118. Machine learning model 118 may, in response, output a natural language response 126, which may be provided by server 110 to client 120. Natural language response 126 may include the requested content (e.g., the user's average monthly spending) in natural language form, such as “your average monthly spending is $3,223.22” or the like.

Natural language response 126 may be displayed via user interface 122. In some embodiments, the user may provide feedback with respect to natural language response 126 (e.g., via user interface 122), such as indicating that the response is accurate or inaccurate, and such feedback may be used to re-train machine learning model 118. For example, if the user confirms that natural language response 126 is accurate, then a new training data instance including natural language request 124, the user's data that was retrieved from star structured database 140 (e.g., an augmented data set), and natural language response 126. Such a training data instance may be used to re-train machine learning model 118 in a similar manner to the training process described above, and the re-trained model may then be used to generate subsequent natural language responses with a higher degree of accuracy.

### Example Automated Generation of Training Data

FIG. 2 is a diagram 200 depicting an example of automated generation of training data for training a language processing machine learning model, according to certain embodiments. Diagram 200 includes star structured database 140 and natural language request/response templates 114 of FIG. 1. For example, diagram 200 may represent functionality performed by training data generator 116 of FIG. 1.

In diagram 200, transaction descriptions 202 and amounts and related data 204 are retrieved from star structured database 140. Transaction descriptions 202 may be brief textual descriptions of transactions (e.g., which may include payments, statements, and/or the like), such as indicating vendors or other parties of transactions, types of products or services, and/or the like, and may be retrieved per user and date. Examples of transaction descriptions 202 include “ABC Gas,” “Benedict's Burgers,” “MGM Direct Trsfr,” and/or the like. In many cases transaction descriptions are populated by financial institutions and include limited information. Amounts and related data 204 may include amounts, dates, times, geographic locations, categories, transaction types, user identifiers, and/or other information associated with the transactions to which transaction descriptions 202 correspond. For example, transaction descriptions 202 and amounts and related data 204 may be stored in relation to one another in star structured database 140, such as in connection with a financial services software application.

At augmentation, 210, transaction descriptions 202 are joined with amounts and related data 204 to produce an augmented data set. At computation 220, one or more computations may be performed based on the augmented data set, such as computing an average monthly spending of a given user (e.g., from all available data for the user, for a particular range of dates, and/or the like). Computation 220 produces a result 222, which may be used to populate a placeholder 236 in a natural language response template 234 associated with a natural language request 232 in natural language request/response templates 114.

For example, natural language request 232 and natural language response template 234 may be an example of a request/response template pair within natural language request/response templates 114. Natural language request 232 includes the text “What is my average monthly spending?” and natural language response template 234 includes the text “Your average monthly spending is { }” where { } is a placeholder 236. Natural language response template 234 may be populated multiple times with ground truth values (e.g., results 222) for multiple users, resulting in multiple training data instances.

Thus, the process depicted in diagram 200 enables ground truth data that is not in natural language form (e.g., transaction descriptions 202 and amounts and related data 204) to be transformed into natural language form (e.g., the populated natural language response template 234). For example, a training data instance may include natural language request 232, the augmented data set (e.g., transaction descriptions 202 joined with amounts and related data 204), and the populated natural language response template 234.

### Example Training of a Language Processing Machine Learning Model

FIG. 3 is a diagram 300 depicting an example of training a language processing machine learning model, according to certain embodiments. Diagram 300 includes machine learning model 118 of FIG. 1 and natural language request 232 and transaction descriptions 202, amounts and related data 204 of FIG. 2. Natural language response label 334 may represent natural language response template 234 of FIG. 2 after being populated with result 222 of FIG. 2. Diagram 200 may represent model training operations performed by model training engine 112 of FIG. 1.

In diagram 300, natural language request 232 is provided (e.g., as a prompt) along with transaction descriptions 202 and amounts and related data 204 (e.g., as context) to machine learning model 118. Machine learning model 118 may produce output 302 in response to the prompt and context. For example, output 302 may include a natural language response.

At block 310, output 302 is evaluated based on natural language response label 334, and one or more parameters of machine learning model 118 are updated based on the evaluation. For example, output 302 may be compared to natural language response label 334, such as via evaluating a cost function, and one or more parameters of machine learning model 118 may be adjusted based on the comparison. Such a process may be repeated iteratively (e.g., with machine learning model 118 generating a new output based on its updated parameters on each iteration) until one or more conditions are met. In some embodiments, the conditions may relate to whether the outputs produced by the model based on the training inputs match the labels associated with the training inputs or whether a measure of error between training iterations is not decreasing or not decreasing more than a threshold amount. The conditions may also include whether a training iteration limit has been reached. Parameters of machine learning model 118 adjusted during training may include, for example, hyperparameters, values related to numbers of iterations, weights, functions used by nodes to calculate scores, and the like. In some embodiments, validation and testing are also performed for machine learning model 118, such as based on validation data and test data, as is known in the art.

### Example Operations for Training a Language Processing Machine Learning Model

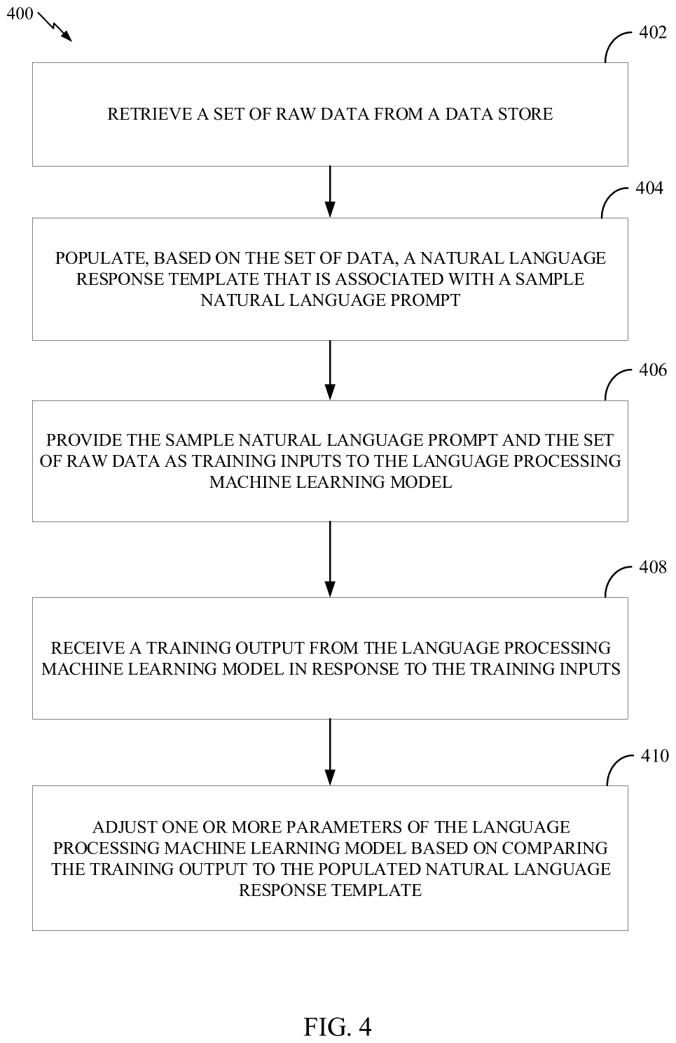

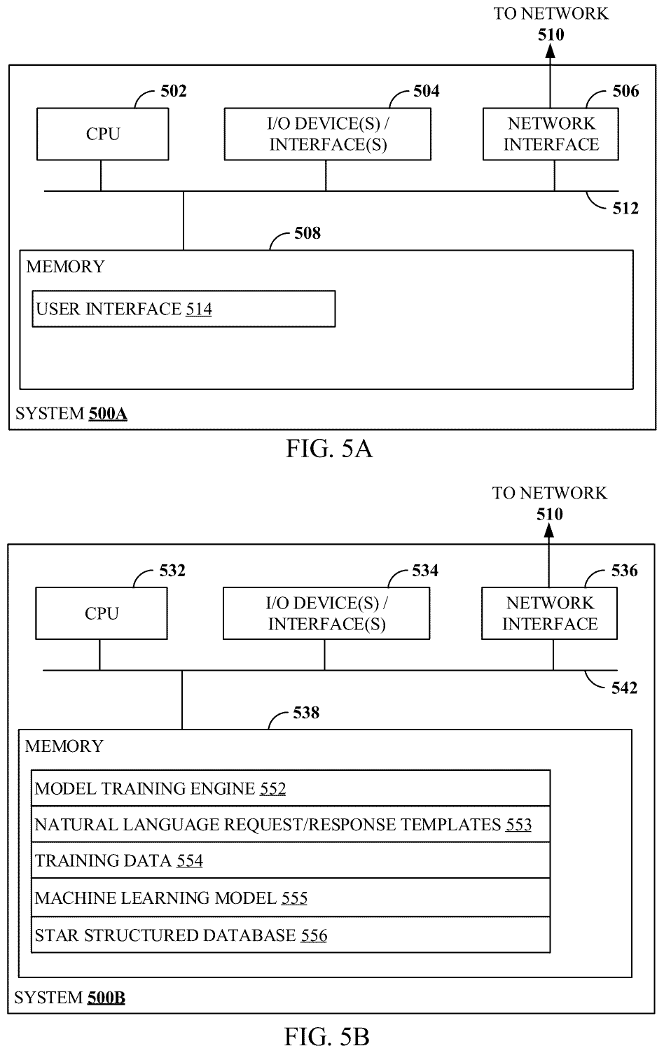

FIG. 4 depicts example operations 400 for training a language processing machine learning model, according to certain embodiments. For example, operations 400 may be performed by one or more components described above with respect to FIGS. 1-3, system 500A or 500B of FIG. 5A or 5B (described below), and/or one or more other components and/or devices. In one example, operations 400 are performed by model training engine 112 of FIG. 1.

Operations 400 begin at step 402, with retrieving a set of raw data from a data store.

In certain embodiments, the data store comprises a star-structured database storing the set of raw data in a relational manner.

Operations 400 continue at step 404, with populating, based on the set of data, a natural language response template that is associated with a sample natural language prompt.

In some embodiments, the populating, based on the set of raw data, the natural language response template comprises performing a computation based on the set of raw data and inserting a result of the performing of the computation into a corresponding location within the natural language response template. In certain embodiments, the performing of the computation comprises aggregating a plurality of values determined based on the set of raw data.

In some embodiments, the plurality of values are not in natural language form.

Operations 400 continue at step 406, with providing the sample natural language prompt and the set of raw data as training inputs to the language processing machine learning model.

Operations 400 continue at step 408, with receiving a training output from the language processing machine learning model in response to the training inputs.

Operations 400 continue at step 410, with adjusting one or more parameters of the language processing machine learning model based on comparing the training output to the populated natural language response template.

Some embodiments further comprise augmenting the set of raw data with other relevant data, and the performing of the computation may be based on the augmenting. In some embodiments the other relevant data comprises one or more of an amount, a geographic location, or a date.

Notably, method 400 is just one example with a selection of example steps, but additional methods with more, fewer, and/or different steps are possible based on the disclosure herein.

### Example Computing Systems

FIG. 5A illustrates an example system 500A with which embodiments of the present disclosure may be implemented. For example, system 500A may be configured to perform one or more of operations 400 of FIG. 4. In one example system 500A corresponds to client 120 of FIG. 1.

System 500A includes a central processing unit (CPU) 502, one or more I/O device interfaces 504 that may allow for the connection of various I/O devices 504 (e.g., keyboards, displays, mouse devices, pen input, etc.) to the system 500A, network interface 506, a memory 508, and an interconnect 512. It is contemplated that one or more components of system 500A may be located remotely and accessed via a network 510. It is further contemplated that one or more components of system 500A may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes a user interface 514, which may be representative of user interface 122 of FIG. 1. For example, a user may interact with user interface 514 to submit natural language requests for data, receive natural language responses including the requested data, provide feedback with respect to natural language responses, and/or the like.

FIG. 5B illustrates another example system 500B with which embodiments of the present disclosure may be implemented. For example, system 500B may correspond to server 110 of FIG. 1, and may be configured to perform one or more of operations 400 of FIG. 4.

System 500B includes a CPU 532, one or more I/O device interfaces 534 that may allow for the connection of various I/O devices 534 (e.g., keyboards, displays, mouse devices, pen input, etc.) to the system 500B, network interface 536, a memory 538, and an interconnect 542. It is contemplated that one or more components of system 500B may be located remotely and accessed via a network 510. It is further contemplated that one or more components of system 500B may comprise physical components or virtualized components.

CPU 532 may retrieve and execute programming instructions stored in the memory 538. Similarly, the CPU 532 may retrieve and store application data residing in the memory 538. The interconnect 542 transmits programming instructions and application data, among the CPU 532, I/O device interface 534, network interface 536, and memory 538. CPU 532 is included to be representative of a single CPU, multiple CPUs, a single CPU having multiple processing cores, and other arrangements.

Additionally, the memory 538 is included to be representative of a random access memory or the like. In some embodiments, memory 538 may comprise a disk drive, solid state drive, or a collection of storage devices distributed across multiple storage systems. Although shown as a single unit, the memory 538 may be a combination of fixed and/or removable storage devices, such as fixed disc drives, removable memory cards or optical storage, network attached storage (NAS), or a storage area-network (SAN).

As shown, memory 538 includes a model training engine 552, natural language request/response templates 553, a machine learning model 555, and a star structured database 556, which may be representative of model training engine 112, natural language request/response templates 114, machine learning model 118, and star structured database 140 of FIG. 1. Memory 538 further includes training data 554, which may include natural language request 232, transaction descriptions 202, amounts and related data 204, and natural language response label 334 of FIG. 3. For example, model training engine 552 may use natural language request/response templates 553 to generate training data 554 based on data from star structured database 556, and may use training data 554 to train machine learning model 555. In other embodiments, star structured database 556 may be located on a separate device from system 500B. In some embodiments, machine learning model 555 is deployed for use on a separate device from system 500B after it is trained.

It is noted that systems 500A and 500B are included as examples, and certain functionality described with respect to systems 500A and/or 500B and/or otherwise described herein may be implemented via more or fewer devices and/or components.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of training a language processing machine learning model, comprising:
retrieving a set of raw data from a data store;
populating, based on the set of data, a natural language response template that is associated with a sample natural language prompt;
providing the sample natural language prompt and the set of raw data as training inputs to the language processing machine learning model;
receiving a training output from the language processing machine learning model in response to the training inputs; and
adjusting one or more parameters of the language processing machine learning model based on comparing the training output to the populated natural language response template.

2. The method of claim 1, wherein the populating, based on the set of raw data, the natural language response template comprises:
performing a computation based on the set of raw data; and
inserting a result of the performing of the computation into a corresponding location within the natural language response template.

3. The method of claim 2, wherein the performing of the computation comprises aggregating a plurality of values determined based on the set of raw data.

4. The method of claim 3, wherein the plurality of values are not in natural language form.

5. The method of claim 2, further comprising augmenting the set of raw data with other relevant data, wherein the performing of the computation is based on the augmenting.

6. The method of claim 1, wherein the other relevant data comprises one or more of:
an amount;
a geographic location; or
a date.

7. The method of claim 1, wherein the data store comprises a star-structured database storing the set of raw data in a relational manner.

8. A system for training a language processing machine learning model, comprising:
one or more processors; and
a memory comprising instructions that, when executed by the one or more processors, cause the system to:
retrieve a set of raw data from a data store;
populate, based on the set of data, a natural language response template that is associated with a sample natural language prompt;
provide the sample natural language prompt and the set of raw data as training inputs to the language processing machine learning model;
receive a training output from the language processing machine learning model in response to the training inputs; and
adjust one or more parameters of the language processing machine learning model based on comparing the training output to the populated natural language response template.

9. The system of claim 8, wherein the populating, based on the set of raw data, the natural language response template comprises:
performing a computation based on the set of raw data; and
inserting a result of the performing of the computation into a corresponding location within the natural language response template.

10. The system of claim 9, wherein the performing of the computation comprises aggregating a plurality of values determined based on the set of raw data.

11. The system of claim 10, wherein the plurality of values are not in natural language form.

12. The system of claim 9, wherein the instructions, when executed by the one or more processors, further cause the system to augment the set of raw data with other relevant data, wherein the performing of the computation is based on the augmenting.

13. The system of claim 8, wherein the other relevant data comprises one or more of:
an amount;
a geographic location; or
a date.

14. The system of claim 8, wherein the data store comprises a star-structured database storing the set of raw data in a relational manner.

15. A non-transitory computer readable medium comprising instructions that, when executed by one or more processors of a computing system, cause the computing system to:
retrieve a set of raw data from a data store;
populate, based on the set of data, a natural language response template that is associated with a sample natural language prompt;
provide the sample natural language prompt and the set of raw data as training inputs to a language processing machine learning model;
receive a training output from the language processing machine learning model in response to the training inputs; and
adjust one or more parameters of the language processing machine learning model based on comparing the training output to the populated natural language response template.

16. The non-transitory computer readable medium of claim 15, wherein the populating, based on the set of raw data, the natural language response template comprises:
performing a computation based on the set of raw data; and
inserting a result of the performing of the computation into a corresponding location within the natural language response template.

17. The non-transitory computer readable medium of claim 16, wherein the performing of the computation comprises aggregating a plurality of values determined based on the set of raw data.

18. The non-transitory computer readable medium of claim 17, wherein the plurality of values are not in natural language form.

19. The non-transitory computer readable medium of claim 16, wherein the instructions, when executed by the one or more processors, further cause the computing system to augment the set of raw data with other relevant data, wherein the performing of the computation is based on the augmenting.

20. The non-transitory computer readable medium of claim 15, wherein the other relevant data comprises one or more of:
an amount;
a geographic location; or
a date.
